(19) United States
(12) Patent Application Publication
(10) Pub. No.: US 2026/0243595 A1
(43) Pub. Date: Aug. 20, 2026

(54) PIEZOELECTRIC SENSOR AND LIQUID LEVEL MEASURING SYSTEM

(71) Applicant: ABB SCHWEIZ AG, Baden (CH)

(72) Inventors: Yongwei Gu, Shanghai (CN); Ying Liu, Shanghai (CN)

(21) Appl. No.: 19/129,214

(22) PCT Filed: Oct. 27, 2022
(86) PCT No.: PCT/CN2022/127995

§ 371 Date: May 12, 2025

(51) Int. Cl. G01F 23/296; G01F 23/00

(52) U.S. Cl. CPC G01F 23/2968; G01F 23/0023

(57) ABSTRACT

A piezoelectric sensor includes a first polarized piezoelectric member having a first polarized direction; a second polarized piezoelectric member having a second polarized direction opposite to the first polarized direction; a first electrical conductor; a second electrical conductor; and a central through hole centrally positioned in the piezoelectric sensor along the central axis and configured to receive a magnetostrictive wire extending along the central axis.

### FIELD

Embodiments of the present disclosure generally relate to a liquid level measuring system that utilize a magnetostrictive wire, and more particularly related to a piezoelectric sensor configured to detect a torsional wave in the magnetostrictive wire.

### BACKGROUND

Many systems for measuring liquid levels in storage tanks, as well as systems for measuring linear displacements for machine tools and the like, utilize a movable permanent magnet float or position indicator that surrounds a linearly oriented magnetostrictive wire. Typically, the position of the permanent magnet represents the position of a monitored quantity of liquid or monitored position of an object of interest.

The use of such a magnetostrictive wire to detect the position of the permanent magnet is well known in the art. For example, U.S. Pat. No. 5,473,245 discloses piezoelectric sensor formed by a piezo ring. The piezo ring comprises 8 segments which are circumferential polarized and are rejoined to a circle by adhesive. U.S. Pat. No. 10,048,291B2 also discloses a piezo sensor comprising a plurality of separate polarized piezoelectric members which are also polarized in a circumferential direction. However, manufacturing and assembling these polarized piezoelectric members are of high cost and time consuming. There is a need to improve the piezoelectric sensor to simplify its structure.

### SUMMARY

Example embodiments of the present disclosure provide a piezoelectric sensor and a liquid level measuring system with improved structure.

In a first aspect of the present disclosure, it is provided a piezoelectric sensor. The piezoelectric sensor comprises: a first polarized piezoelectric member comprising a first circumferential end and a second circumferential end, a first polarized direction of the first polarized piezoelectric member being along a central axis; a second polarized piezoelectric member arranged adjacent to the first polarized piezoelectric member along a circumferential direction, the second polarized piezoelectric member comprising a first circumferential end circumferentially adjacent to the first circumferential end of the first polarized piezoelectric member and a second circumferential end circumferentially adjacent to the second circumferential end of the first polarized piezoelectric member, a second polarized direction of the second polarized piezoelectric member being opposite to the first polarized direction; a first electrical conductor disposed between the first circumferential end of the first polarized piezoelectric member and the first circumferential end of the second polarized piezoelectric member and configured to be connected to the first circumferential end of the first polarized piezoelectric member and the first circumferential end of the second polarized piezoelectric member; a second electrical conductor disposed between the second circumferential end of the first polarized piezoelectric member and the second circumferential end of the second polarized piezoelectric member and configured to be connected to the second circumferential end of the first polarized piezoelectric member and the second circumferential end of the second polarized piezoelectric member; and a central through hole centrally positioned in the piezoelectric sensor along the central axis and configured to receive a magnetostrictive wire extending along the central axis.

In the present disclosure, structure of the piezoelectric sensor is simplified resulting reduced cost without compromising detection accuracy.

In some embodiments, the first polarized piezoelectric member and the second polarized piezoelectric member may be symmetrically arranged with respect to the center axis. With this arrangement, the vibration mode caused by the torsional wave can be easily detected with the polarized piezoelectric member.

In some embodiments, the first polarized piezoelectric member and the second polarized piezoelectric member may be arranged in a substantially annular ring. With this arrangement, the polarized piezoelectric member can be easily manufactured in a cost-effective way.

In some embodiments, the first polarized piezoelectric member and the second polarized piezoelectric member may be substantially in a shape of a semi-cylindrical ring, and the respective first and second circumferential end portions may comprise a rectangular cross-sectional shape. With this arrangement, this shape is helpful in detecting the vibration mode caused by the torsional wave.

In some embodiments, the piezoelectric sensor may further comprise an insulating intermediate member arranged at a radial inner side of the first polarized piezoelectric member and the second polarized piezoelectric member and configured to be in contact with radial inner surfaces of the first polarized piezoelectric member and the second polarized piezoelectric member, the central through hole being formed in the insulating intermediate member. With this arrangement, shear force caused by the torsional wave can be effectively transmitted to the polarized piezoelectric members.

In some embodiments, the first polarized piezoelectric member and the second polarized piezoelectric member may comprise at least one size of: an inner diameter of the first polarized piezoelectric member and the second polarized piezoelectric member being in a range of 4±2 mm; an outer diameters of the first polarized piezoelectric member and the second polarized piezoelectric member being in a range of 9±2 mm; or a thickness of the first polarized piezoelectric member and the second polarized piezoelectric member being in a range of 5±2 mm. With this arrangement, the vibration mode caused by the torsional wave can be easily detected with the polarized piezoelectric member.

In some embodiments, the first electrical conductor may be attached to the first circumferential ends of the first polarized piezoelectric member and the second polarized piezoelectric member by conductive adhesive. In some embodiments, the second electrical conductor may be attached to the second circumferential ends of the first polarized piezoelectric member and the second polarized piezoelectric member by conductive adhesive. With these arrangements, the electrical conductors can be easily attached to the polarized piezoelectric members.

In some embodiments, the first electrical conductor and the second electrical conductor each may comprise a portion which protrudes above the first and second polarized piezoelectric members in the central axis.

In some embodiments, the piezoelectric sensor may further comprise an insulating sleeve circumferentially surrounding the first and second polarized piezoelectric members radially outside the first and second polarized piezoelectric members. In some embodiments, the insulating sleeve may be made of ceramics. With these arrangements, the polarized piezoelectric members can be well protected.

In a second aspect of the present disclosure, it is provided a piezoelectric sensor. The piezoelectric sensor comprises: a plurality of paired polarized piezoelectric members arranged adjacently along the circumferential direction, the paired polarized piezoelectric members each comprising a first polarized piezoelectric member comprising a first polarized direction along the central axis and a second polarized piezoelectric member comprising a second polarized direction opposite to the first polarized direction, the first polarized piezoelectric member comprising a first circumferential end and a second circumferential end, the second polarized piezoelectric member comprising a first circumferential end circumferentially adjacent to the first circumferential end of the first polarized piezoelectric member and a second circumferential end, polarized directions of two adjacent polarized piezoelectric members arranged along the circumferential direction being opposite; a plurality of first electrical conductors circumferentially disposed between and connected to the first circumferential ends of each paired polarized piezoelectric members, the plurality of first electrical conductors being connected in series to form a first output; a plurality of second electrical conductors circumferentially disposed between and connected to the second circumferential end of the first polarized piezoelectric member in a first paired polarized piezoelectric members and the second circumferential end of the second polarized piezoelectric member in a second paired polarized piezoelectric members circumferentially adjacent to the first paired polarized piezoelectric members, the plurality of second electrical conductors being connected in series to form a second output; and a central through hole centrally positioned in the piezoelectric sensor along the central axis, the central hole configured to receive a magnetostrictive wire extending along the central axis.

In a third aspect of the present disclosure, it is provided a liquid level measuring system. The liquid level measuring system comprises: a magnetostrictive wire; a permanent magnet movable along the magnetostrictive wire based on the liquid level; a piezoelectric sensor according to any of first and second aspects; and a processing device configured to: send an electric current to the magnetostrictive wire which causes a torsional wave in the magnetostrictive wire; receive a signal from the piezoelectric sensor caused by the torsional wave; and determine the liquid level based on the received signal.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic view of a liquid level measuring system according to one example embodiment of the present disclosure;

FIG. 2 is a enlarged view of a circled portion in FIG. 1;

FIG. 3 is a schematic perspective view of a piezoelectric sensor according to one example embodiment of the present disclosure;

FIG. 4 is a sectional view of the piezoelectric sensor in FIG. 3;

FIG. 5 is a schematic perspective view of a piezoelectric sensor according to on example embodiment of the present disclosure; and

FIG. 6 is a schematic perspective view of a piezoelectric sensor according to another example embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “ and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Use of the magnetostrictive principle involves the creation of an initial current pulse within a magnetostrictive wire to create a magnetic field along the length of the wire. The magnetic field interacts with the magnetic field that is present at the permanent magnet's location, resulting in a torsional disturbance in the wire. Because a torsional wave is essentially an acoustic wave, its speed of propagation is sufficiently slow and measurable that a direct relationship can be established between the time it takes for the wave to travel, and the distance traveled. When the length the magnetostrictive wire are known and the initial start time for the torsional pulse is known, detection of the torsional pulse at a detector suitably positioned will provide a travel time value directly related to the distance traveled by the torsional pulse. This distance is then used to determine the level of a liquid within a tank or the position of a machine tool as it works an object of concern.

Piezoelectric sensors are used to detect the arrival of the torsional wave. Piezoelectric sensors have been shown to be most useful in accurately detecting and discriminating the arrival of the torsional pulse with an accuracy sufficient for many applications. Piezoelectric sensors comprise piezoelectric materials which include certain ceramics, naturally occurring crystals, and manmade crystals. The piezoelectric material can be used to detect and convert a torsional wave detected in the wire into an electric signal.

Normal operational mode of piezoelectric sensors is in a shear mode. Conventional piezoelectric sensors are constructed from a plural of segments of piezo crystal, each being separately polarized in a circumferential direction and circumferential joined to form the piezoelectric sensor. However, to manufacture such a piezoelectric sensor is labor intensive. The assembled piezo crystal elements must be machined to very close tolerances on both the inner annulus surface and the adjoining crystal faces. In order to provide a detector of sufficiently accurate character, extensive hand labor is needed to complete a multi-segmented piezo crystal sensor.

The present discloses provides a completely novel configuration of a piezoelectric sensor which comprises polarized segments having a polarized direction in an axial direction rather than in the circumferential direction. This novel design significantly reduce assembling labor and time for manufacturing the piezoelectric sensor without compromising the torsional wave detection performances. Through the following detailed descriptions with reference to the accompanying drawings, the above features and advantages of the example embodiments disclosed herein will become more comprehensible.

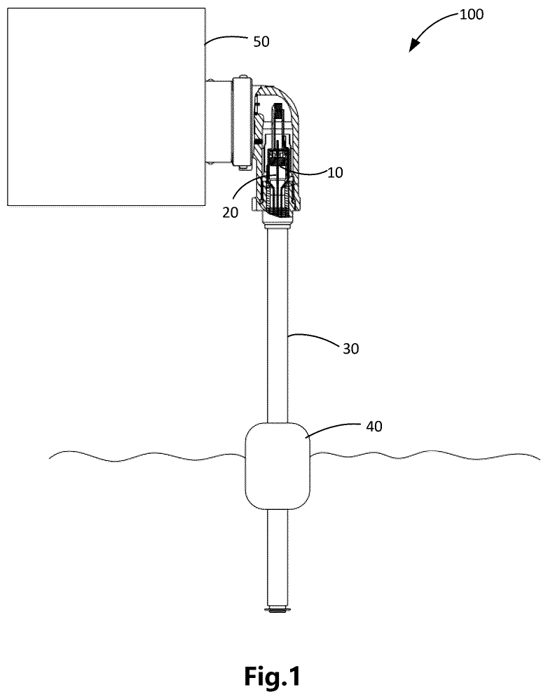

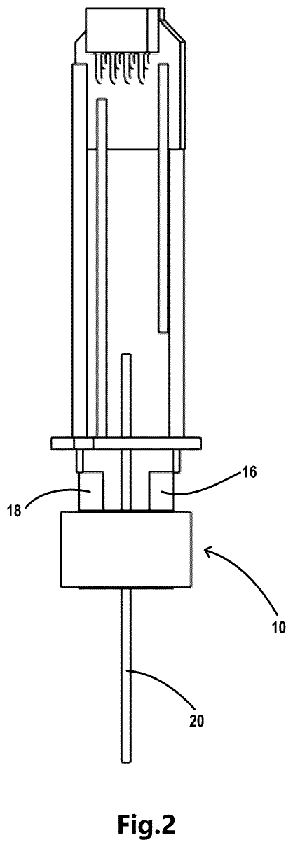

FIGS. 1 and 2 shows a schematic view of a liquid level measuring system 100 according to one example embodiment of the present disclosure. As shown in FIG. 1, the liquid level measuring system 100 comprises a frame 60 and a tube 30. The frame 60 may be mounted at a proper position of an object for example, a tank containing the liquid. The frame may also comprise various electrical means for operating the piezoelectric sensor. For example, the electrical means may include a pulsing circuit for generating a current pulse to the magnetostrictive wire which causes a torsional wave in the magnetostrictive wire 20, and a microprocessor-based electronics for processing electrical signals from the piezoelectric sensor caused by the torsional wave to determine the liquid level.

As shown in FIG. 1, a permanent magnet 40 (or namely a magnetic float) is mounted on or in the tube 30. The permanent magnet 40 floats on the surface of the liquid and is movable as the liquid level changes. The piezoelectric sensor 10 is arranged within the tube 30. The piezoelectric sensor 10 is also electrically connected to the microprocessor-based electronics and is configured to detect the electric signal caused by a torsional wave on the magnetostrictive wire 20. The magnetostrictive wire 20 is arranged in a central hole of the piezoelectric sensor 10 and axially extends in the tube 30.

The operation principle of the system is described below. An electrical current (for example, a current pulse) is sent to the magnetostrictive wire 20. The electrical current creates a magnetic field which travels down along the magnetostrictive wire within the tube 30. An interaction of the magnetic field around the magnetostrictive wire and the magnetic float 40 causes a torsional stress wave to be induced in the magnetostrictive wire. This torsion propagates along the magnetostrictive wire at a known velocity, from the position of the magnetic float and toward both ends of the magnetostrictive wire. The piezoelectric sensor 10 is configured detect the received mechanical torsion into an electrical return signal. The microprocessor-based electronics is configured to determine elapsed time between the start and return current time of flight and converts it into a position measurement which is proportional to the level of the magnetic float. In this way, the liquid level can be reliably determined. By periodically sending the electrical current to the magnetostrictive wire 20, the liquid level can be detected in time when a position of the magnetic float 40 changes.

As shown in FIG. 2, the piezoelectric sensor 10 is mounted at a proper position for example, an end point of the magnetostrictive wire 20, and serves to function primarily as a means for detecting the occurrence of a torsional wave front at that end point. The piezoelectric sensor 10 is connected to microprocessor-based electronics via the conductors 16, 18.

It is to be understood that in the shown example the piezoelectric sensor is shown as functioning primarily as a means for detecting the occurrence of a torsional wave. This is merely illustrative and the piezoelectric element may be used in a different manner. For example, the piezoelectric element could be utilized to impart a torsional wave to a magnetostrictive wire 20 with detection of a current flow in the magnetostrictive wire.

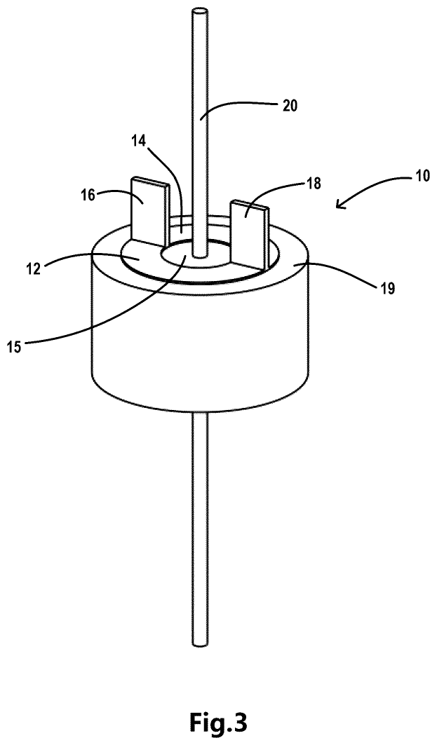

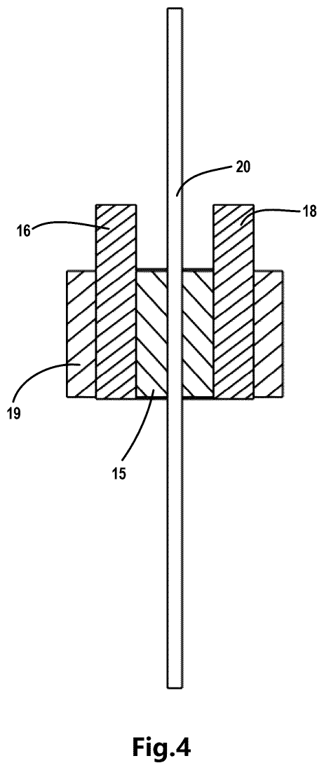

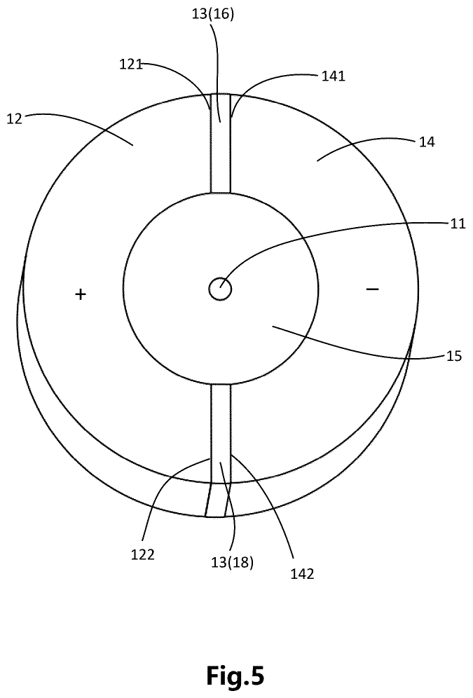

Reference is now made to FIGS. 3-5 for a detailed description of the configuration of an improved piezoelectric sensor. FIG. 3 is a schematic perspective view of a piezoelectric sensor according to one example embodiment of the present disclosure. FIG. 4 shows a sectional view of a piezoelectric sensor according to one example embodiment of the present disclosure. FIG. 5 is a schematic perspective view of a simplifed version of the piezoelectric sensor according to an example embodiment of the present disclosure, with the magnetostrictive wire 20 and electrical conductors removed for sake of clarity.

As shown in FIGS. 3-5, the piezoelectric sensor 10 comprises a first polarized piezoelectric member 12 and a second polarized piezoelectric member 14. The first polarized piezoelectric member 12 has a first circumferential end 121 and a second circumferential end 122. The first polarized piezoelectric member 12 has a first polarized direction along a central axis direction. As shown in FIG. 5, the first polarized direction of this first polarized piezoelectric member 12 is marked by a positive sign “+”. This central axis direction is also the extending direction of the magnetostrictive wire 20. In the first polarized piezoelectric member 12, the polarized direction is in the central axis direction.

The second polarized piezoelectric member 14 is of the same shape as the first polarized piezoelectric member 12. The second polarized piezoelectric member 14 is circumferentially opposite the first polarized piezoelectric member 12 and is arranged adjacent to the first polarized piezoelectric member 12 along a circumferential direction. The second polarized piezoelectric member 14 has a first circumferential end 141 circumferentially adjacent to the first circumferential end 121 of the first polarized piezoelectric member 12 and a second circumferential end 142 circumferentially adjacent to the second circumferential end 122 of the first polarized piezoelectric member 12. The second polarized piezoelectric member 14 has a second polarized direction opposite to the first polarized direction. As shown in FIG. 5, the second polarized direction of the second polarized piezoelectric member 14 is marked by a negative sign “−” to distinguish from the polarized direction of the second polarized piezoelectric member 14.

A first electrical conductor 16 is also disposed between the first circumferential end 121 of the first polarized piezoelectric member 12 and the first circumferential end 141 of the second polarized piezoelectric member 14. The first electrical conductor 16 is configured to be connected to the first circumferential end 121 of the first polarized piezoelectric member 12 and the first circumferential end 141 of the second polarized piezoelectric member 14. The first electrical conductor is made of electrical conductive materials and may be of various shapes. In the shown example, the first electrical conductor is of a shape of conductive sheet with a rectangular cross section. It is to be understood that this is merely illustrative and the first electrical conductor may be of any other proper shapes. By the first electrical conductor 16, electrical connection can be established between the first circumferential end 121 of the first polarized piezoelectric member 12 and the first circumferential end 141 of the second polarized piezoelectric member 14. In this way, the electrical signal generated at the respective electrode of the first polarized piezoelectric member 12 and the second polarized piezoelectric member 14 can be output.

Likewise, a second electrical conductor 18 is disposed between the second circumferential end 122 of the first polarized piezoelectric member 12 and the second circumferential end 142 of the second polarized piezoelectric member 14 and configured to be connected to the second circumferential end of the first polarized piezoelectric member 12 and the second circumferential end of the second polarized piezoelectric member 14. Likewise, the second electrical conductor 18 is made of electrical conductive materials. In the shown example, the first electrical conductor is of a shape of conductive sheet with a rectangular cross section. By the second electrical conductor 18, electrical connection can be established between the second circumferential end 122 of the first polarized piezoelectric member 12 and the second circumferential end 142 of the second polarized piezoelectric member 14. In this way, the electrical signal generated at the respective electrodes of the first polarized piezoelectric member 12 and the second polarized piezoelectric member 14 can be output.

The piezoelectric sensor 10 also includes a central through hole 11 which is centrally positioned in the piezoelectric sensor 10 along the central axis and configured to receive a magnetostrictive wire 20 extending along the central axis. A size of the central through hole 11 is configured to transmit the torsional wave or a shear force from the magnetostrictive wire 20 to the first polarized piezoelectric member 12 and the second polarized piezoelectric member 14.

In the present disclosure, the first polarized piezoelectric member 12 and the second polarized piezoelectric member 14 have a polarized direction in the central axis rather than in the circumferential direction. This is different from the conventional piezoelectric sensor. The operation principle of this polarized pattern is described below. When the magnetostrictive wire 20 vibrates in a circumferential direction, the first polarized piezoelectric member 12 and the second polarized piezoelectric member 14 with opposite polarized directions in the central axis according to the present disclosure are found to generate a vibration mode along the circumferential direction. Thus, by detecting the electrical output of the circumferential end surfaces of the first polarized piezoelectric member 12 and the second polarized piezoelectric member 14, the torsional wave on the magnetostrictive wire 20 can be detected with sufficient accuracy.

In the present disclosure, since the polarization direction of the piezoelectric member 12 and the second polarized piezoelectric member 14 are in the central axis direction, it is easy to manufacture the polarized piezoelectric member. Also, it is cost effective to assemble the manufactured piezoelectric members. In this way, the cost of the piezoelectric sensor is reduced.

In particular, dimension tolerances of inner and/or outer diameter of each polarized piezoelectric member can be well controlled. That is because these polarized piezoelectric members can be directly formed by piezo molding process, which have quite good quality consistency. As for the conventional piezoelectric sensor, the polarized member has a polarized direction in the circumferential direction has to be ground by the sandpaper so as to be tightly close to each other. As for the piezoelectric sensor of the present disclosure, there is no need of grinding operations with sandpaper which may cause large variations.

Moreover, in the present disclosure, electrodes of the first piezoelectric member 12 and the second polarized piezoelectric member 14 are arranged between the circumferential end areas of the first piezoelectric member 12 and the second polarized piezoelectric member 14. The electrodes of the first piezoelectric member 12 and the second polarized piezoelectric member 14 are further connected to the first electrical conductor 16 and the second electrical conductor 18. Interfaces for transmitting torsional wave from the magnetostrictive wire 20 to the d piezoelectric members are reduced. The interface reduction not only removes tolerance uncertainty, but also reduces signal attenuation by fewer material loss along with propagation.

In some embodiments, as shown in FIGS. 3-5, the first polarized piezoelectric member 12 and the second polarized piezoelectric member 14 are symmetrically arranged with respect to the center axis. This is advantageous in detecting vibration mode in the circumferential direction by the first and second polarized piezoelectric members 12, 14 having opposite polarized direction along the axial direction.

In some embodiments, as shown in FIGS. 3-5, the first polarized piezoelectric member 12 and the second polarized piezoelectric member 14 each are substantially in a shape of a semi-cylindrical ring. The first polarized piezoelectric member 12 and the second polarized piezoelectric member 14 together form a substantially annular ring. The respective first and second circumferential end portions have a rectangular cross-sectional shape. This is advantageous in detecting circumferential vibration mode caused by the torsional wave. Also, this is advantageous in manufacturing. That is because the circumferential ends of adjacent piezoelectric members must be either rigid or have a high inertial mass. When the circumferential end portions of the piezoelectric members have a rectangular cross-sectional shape, the piezoelectric members can be easily aligned to avoid introducing false signals and nulling undesired vibrational response.

In some embodiments, the first polarized piezoelectric member 12 and the second polarized piezoelectric member 14 each are in a shape of an arc-cylindrical section as long as the circumferential vibration mode can be detected by the piezoelectric material of the piezoelectric members.

In some embodiments, the central hole 11 is formed by the first polarized piezoelectric member 12 and the second polarized piezoelectric member 14. In other embodiments, an insulating intermediate member 15 may be provided at a radial inner side of the first polarized piezoelectric member 12 and the second polarized piezoelectric member 14 and configured to be in contact with radial inner surfaces of the first polarized piezoelectric member 12 and the second polarized piezoelectric member 14. The central through hole 11 is formed in the insulating intermediate member 15. With the arrangement of the insulating intermediate member 15, the first polarized piezoelectric member 12 and the second polarized piezoelectric member 14 can be formed to be a size that can induce enhanced circumferential vibration mode in the piezoelectric members.

The insulating intermediate member 15 may be formed from any proper insulating material. In some embodiments, the insulating intermediate member 15 is formed of potting glue. This is advantageous in assembling the piezoelectric sensor. When the first polarized piezoelectric member 12 and the second polarized piezoelectric member 14 are assembled together, the open space formed by the inner surfaces of the first polarized piezoelectric member 12 and the second polarized piezoelectric member 14 can be filled by potting glue. The potting glue then cures to form a rigid structure. The fit tolerances between the magnetostrictive wire 20 and the first and second polarized piezoelectric members 12,14 should be well controlled since the shear force in the magnetostrictive wire 20 is to be transmitted to the inner surfaces of the first and second polarized piezoelectric members 12,14. Due to the potting glue, fit tolerances from the magnetostrictive wire 20 to the first and second polarized piezoelectric members 12,14 can be removed.

In some embodiments, a size of the first polarized piezoelectric member 12 and the second polarized piezoelectric member 14 meets at least one of the following requirements. An inner diameter of the first polarized piezoelectric member 12 and the second polarized piezoelectric member 14 is in a range of 4±2 mm, for example 4 mm. An outer diameter of the first polarized piezoelectric member 12 and the second polarized piezoelectric member 14 is in a range of 9±2 mm, for example, 9 mm. A thickness (i.e., a size in the central axis direction) of the first polarized piezoelectric member 12 and the second polarized piezoelectric member 14 is in a range of 5±2 mm, for example, 5 mm. Experiment tests show that when the size of the polarized piezoelectric member meet the above experiments, the circumferential vibration mode of the polarized piezoelectric member for generating electrical output can be improved.

The first electrical conductor 16 and the second electrical conductor 18 may be various forms. In some embodiments, the first electrical conductor 16 and the second electrical conductor 18 are in form rectangular shaped sheet. In the shown example, the first electrical conductor 16 and the second electrical conductor 18 covers the entire electrode surfaces of the first polarized piezoelectric member 12 and the second polarized piezoelectric member 14 that are arranged at the circumferential end of the respective polarized piezoelectric member. In some example, the first electrical conductor 16 and the second electrical conductor 18 covers a portion of the electrode surfaces of the first polarized piezoelectric member 12 and the second polarized piezoelectric member 14.

In some embodiments, the first electrical conductor 16 is attached to the first circumferential ends 121, 141 of the first polarized piezoelectric member 12 and the second polarized piezoelectric member 14 by conductive adhesive 13. In this case, fit tolerances between the first and second polarized piezoelectric members 12, 14 can be removed or absorbed by the conductive adhesive 13. Likewise, the second electrical conductor 18 is attached to the second circumferential ends 122, 142 of the first polarized piezoelectric member 12 and the second polarized piezoelectric member 14 by conductive adhesive 13.

In some embodiments, as shown in FIGS. 3-5, the first electrical conductor 16 and the second electrical conductor 18 comprise a portion which protrudes above the first and second polarized piezoelectric members 12, 14 in the central axis direction. With the portion, the electrical connection can be easily established at the first electrical conductor 16 and the second electrical conductor 18.

In some embodiments, as shown in FIGS. 3-5, the piezoelectric sensor 10 comprises an insulating sleeve 19 circumferentially surrounding the first and second polarized piezoelectric members 12, 14 radially outside the first and second polarized piezoelectric members 12, 14. With the insulating sleeve 19, the piezoelectric members can be well protected. In some embodiments, the insulating sleeve 19 is made of ceramics. It is to be understood this is merely illustrative. Outside the first and second polarized piezoelectric members 12, 14, other protection means can be provided as long as the operation of the piezoelectric members is not influenced.

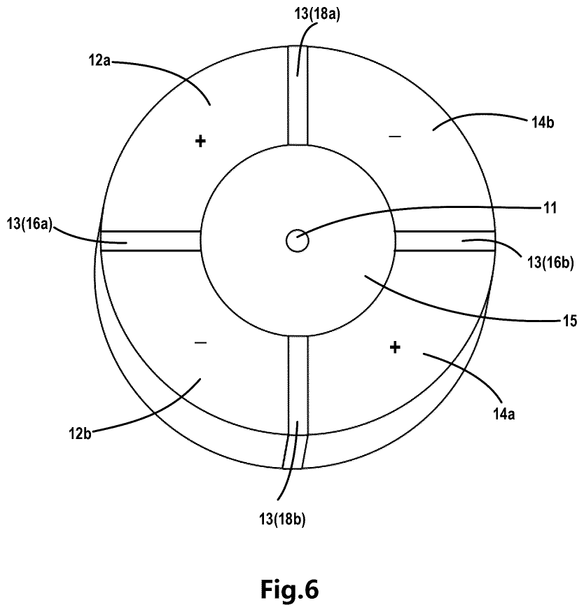

FIG. 6 shows schematic perspective view of a piezoelectric sensor according to another example embodiment of the present disclosure. The piezoelectric sensor shown in FIG. 6 is substantially the same as that shown in FIG. 5. The difference is that there are two paired polarized piezoelectric members in the piezoelectric sensor of FIG. 5 rather than a pair of polarized piezoelectric members as show in FIG. 5.

As shown in FIG. 6, there are two paired polarized piezoelectric members arranged adjacently along the circumferential direction. The paired polarized piezoelectric members each comprise a first polarized piezoelectric member 12a and a second polarized piezoelectric member 12b. The first polarized piezoelectric member 12a has a first polarized direction along the central axis direction (shown by a positive sign “+” in FIG. 6). The second polarized piezoelectric member 12b has a second polarized direction opposite to the first polarized direction (shown by a negative sign “−” in FIG. 6).

In the shown embodiment, each polarized piezoelectric member 12a, 12b, 14a, 14b are of the same size and are of cylindrical segment shape. Two adjacent polarized piezoelectric members are arranged along the circumferential direction having opposite polarized directions. To be specific, the reference signs “+” and “−” alternates in the circumferential direction. The two adjacent polarized piezoelectric members can be connected together for example by conductive adhesive 13. The electrical conductors 16a, 16b, 18a, 18b is disposed between and in electrical contact with two adjacent polarized piezoelectric members.

To be specific, the first polarized piezoelectric member 12a, 14a has a first circumferential end and a second circumferential end. The second polarized piezoelectric member 12b, 14b has a first circumferential end circumferentially adjacent to the first circumferential end and a second circumferential end. Two first electrical conductors 16a, 16b are circumferentially disposed between and in electrical contact with the first circumferential ends of each paired polarized piezoelectric members respectively. The first electrical conductors 16a, 16b are connected in series to form a first output.

Likewise, two second electrical conductors 18a, 18b are circumferentially disposed between and in electrical contact with the second circumferential end of the first polarized piezoelectric member 12a in a first paired polarized piezoelectric members and the second circumferential end of the second polarized piezoelectric member 14b in a second paired polarized piezoelectric members circumferentially adjacent to the first paired polarized piezoelectric members. The two second electrical conductors 18a, 18b are connected in series to form a second output.

With the above arrangement, tests show that the piezoelectric sensor can detect the electrical output from the polarized piezoelectric members with sufficient accuracy. It is to be understood that in the shown example only two paired piezoelectric members are included. This is merely illustrative. In some other embodiments, the piezoelectric sensor may include three or more paired piezoelectric members.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. A piezoelectric sensor comprising:
a first polarized piezoelectric member comprising a first circumferential end and a second circumferential end, a first polarized direction of the first polarized piezoelectric member being along a central axis,
a second polarized piezoelectric member arranged adjacent to the first polarized piezoelectric member along a circumferential direction, the second polarized piezoelectric member comprising a first circumferential end circumferentially adjacent to the first circumferential end of the first polarized piezoelectric member and a second circumferential end circumferentially adjacent to the second circumferential end of the first polarized piezoelectric member, a second polarized direction of the second polarized piezoelectric member being opposite to the first polarized direction,
a first electrical conductor disposed between the first circumferential end of the first polarized piezoelectric member and the first circumferential end of the second polarized piezoelectric member and configured to be connected to the first circumferential end of the first polarized piezoelectric member and the first circumferential end of the second polarized piezoelectric member;
a second electrical conductor disposed between the second circumferential end of the first polarized piezoelectric member and the second circumferential end of the second polarized piezoelectric member and configured to be connected to the second circumferential end of the first polarized piezoelectric member and the second circumferential end of the second polarized piezoelectric member; and
a central through hole centrally positioned in the piezoelectric sensor along the central axis and configured to receive a magnetostrictive wire extending along the central axis.

2. The piezoelectric sensor according to claim 1, wherein the first polarized piezoelectric member and the second polarized piezoelectric member are symmetrically arranged with respect to the center axis.

3. The piezoelectric sensor according to claim 1, wherein the first polarized piezoelectric member and the second polarized piezoelectric member are arranged in a substantially annular ring.

4. The piezoelectric sensor according to claim 3, wherein the first polarized piezoelectric member and the second polarized piezoelectric member are substantially in a shape of a semi-cylindrical ring, and the respective first and second circumferential end portions comprise a rectangular cross-sectional shape.

5. The piezoelectric sensor according to claim 1, further comprising an insulating intermediate member arranged at a radial inner side of the first polarized piezoelectric member and the second polarized piezoelectric member and configured to be in contact with radial inner surfaces of the first polarized piezoelectric member and the second polarized piezoelectric member, the central through hole being formed in the insulating intermediate member.

6. The piezoelectric sensor according to claim 5, wherein the insulating intermediate member is formed of cured potting glue.

7. The piezoelectric sensor according to claim 1, wherein the first polarized piezoelectric member and the second polarized piezoelectric member comprise at least one size of:
an inner diameter of the first polarized piezoelectric member and the second polarized piezoelectric member being in a range of 4±2 mm;
an outer diameters of the first polarized piezoelectric member and the second polarized piezoelectric member being in a range of 9±2 mm; or
a thickness of the first polarized piezoelectric member and the second polarized piezoelectric member being in a range of 5±2 mm.

8. The piezoelectric sensor according to claim 1, wherein the first electrical conductor is attached to the first circumferential ends of the first polarized piezoelectric member and the second polarized piezoelectric member by conductive adhesive.

9. The piezoelectric sensor according to claim 1, wherein the second electrical conductor is attached to the second circumferential ends of the first polarized piezoelectric member and the second polarized piezoelectric member by conductive adhesive.

10. The piezoelectric sensor according to claim 1, wherein the first electrical conductor and the second electrical conductor each comprises a portion which protrudes above the first and second polarized piezoelectric members in the central axis.

11. The piezoelectric sensor according to claim 1, further comprising an insulating sleeve circumferentially surrounding the first and second polarized piezoelectric members radially outside the first and second polarized piezoelectric members.

12. The piezoelectric sensor according to claim 11, wherein the insulating sleeve is made of ceramics.

13. A piezoelectric sensor comprising:
a plurality of paired polarized piezoelectric members arranged adjacently along the circumferential direction, the paired polarized piezoelectric members each comprising a first polarized piezoelectric member comprising a first polarized direction along the central axis and a second polarized piezoelectric member comprising a second polarized direction opposite to the first polarized direction, the first polarized piezoelectric member comprising a first circumferential end and a second circumferential end, the second polarized piezoelectric member comprising a first circumferential end circumferentially adjacent to the first circumferential end of the first polarized piezoelectric member and a second circumferential end, polarized directions of two adjacent polarized piezoelectric members arranged along the circumferential direction being opposite;
a plurality of first electrical conductors circumferentially disposed between and connected to the first circumferential ends of each paired polarized piezoelectric members, the plurality of first electrical conductors being connected in series to form a first output;
a plurality of second electrical conductors circumferentially disposed between and connected to the second circumferential end of the first polarized piezoelectric member in a first paired polarized piezoelectric members and the second circumferential end of the second polarized piezoelectric member in a second paired polarized piezoelectric members circumferentially adjacent to the first paired polarized piezoelectric members, the plurality of second electrical conductors being connected in series to form a second output; and
a central through hole centrally positioned in the piezoelectric sensor along the central axis, the central hole configured to receive a magnetostrictive wire extending along the central axis.

14. A liquid level measuring system comprising:
a magnetostrictive wire;
a permanent magnet movable along the magnetostrictive wire based on the liquid level;
the piezoelectric sensor according claim 1; and
a processing device configured to:
send an electric current to the magnetostrictive wire which causes a torsional wave in the magnetostrictive wire;
receive a signal from the piezoelectric sensor caused by the torsional wave; and
determine the liquid level based on the received signal.
